(19) United States
(12) Patent Application Publication
(10) Pub. No.: US 2006/0071985 A1
(43) Pub. Date: Apr. 6, 2006

(54) Fluid sensing apparatus for an ink supply system

(76) Inventors: Patrick J. Therien, Battle Ground, WA (US); Sarah Suffield, Vancouver, WA (US); Isaac Farr, Corvallis, OR (US); Shane Shivji, Corvallis, OR (US); Ronald A. Juve, Brush Prairie, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/013,604

(22) Filed: Dec. 15, 2004

Related U.S. Application Data
(60) Provisional application No. 60/616,882, filed on Oct. 6, 2004.

(51) Int. Cl. B41J 2/17

(52) U.S. Cl. 347/84

(57) ABSTRACT

An apparatus for use with an ink supply system of a printer includes a housing having an inlet, an outlet and a longitudinal fluid conduit extending therebetween. A fluid sensing device extends from a first side of the fluid conduit to an opposite side of the fluid conduit. A monitoring device is electrically coupled to the fluid sensing device for detecting changes in the fluid sensing device.

### CLAIM OF PRIORITY

This application claims the benefit of U.S. Provisional Application No. 60/616,882, filed on Oct. 6, 2004, and titled FLUID SENSING APPARATUS FOR AN INK SUPPLY SYSTEM.

### BACKGROUND

Ink jet printers offer a mechanism for producing high print quality using inexpensive print materials. Typically, a print head includes a silicon substrate having hundreds of tiny nozzles per inch, each nozzle ejecting droplets of ink under the control of a microprocessor. The print head is usually mounted within a moveable pen that travels on a carriage directly over a paper conveyance path. In black and white printing, a single ink supply and print head is used, whereas two or more ink supplies and associated print heads are normally used in color printing. Conventionally, in home printers the ink supply is contained directly in each pen, and the pen usually must be completely replaced when the ink is depleted. In larger ink jet printers used in some commercial applications, the ink supply is usually remote from the pen (so-called off-axis printing) due to the large ink supply required. In some embodiments of off-axis printers, an ink supply may be contained directly in each pen, and the on-pen ink supply is then periodically or continuously refilled from a remote ink supply.

In both home and commercial applications, detection and monitoring of fluids (ink, air and ink/air mixtures) within the ink supply system is important. The ability to accurately detect and monitor the presence and status of fluids in the ink supply system is useful for many purposes, including determining ink flow rates, determining remaining ink volumes, identifying an out of ink condition, and regulating back pressure of the print head assembly, for example. The monitoring, control and regulation of fluids is usually more difficult in the ink supply systems of off-axis printers, due to the ink reservoir being remote from the print head.

One problem with current fluid sensing technologies such as optical sensors, continuity sensors, mass flow sensors, etc., is that such sensors tend to require an additional sensor module that takes up scarce space in the printer and provides only a single function. This problem is exacerbated in printers that use multiple ink colors and have a corresponding number of ink delivery systems. A separate sensing module is required for every ink delivery system within the printer. The multiple sensing modules increase the complexity and cost of the printer, and do not lend themselves to a compact printer design. A need exists for a fluid sensor that addresses these deficiencies.

### BRIEF DESCRIPTION OF THE DRAWINGS

FIG. 1 is a schematic illustration of an ink supply system in an ink jet printer having a fluid sensor assembly in accordance with an exemplary embodiment.

FIGS. 2A and 2B are perspective front and back illustrations of an embodiment of a fluid sensor assembly.

FIG. 3 is a perspective illustration of the fluid sensor assembly embodiment of FIGS. 2A-2B attached to a printed circuit board.

FIG. 4A is a sectional illustration of the fluid sensor assembly taken along line 4-4 of FIG. 3.

FIG. 4B is a sectional illustration of another exemplary embodiment of a fluid sensor assembly, showing an annular fluid sensing elements.

FIG. 5 is a perspective illustration of the fluid sensor assembly of FIGS. 1-4 in an exemplary ink supply system.

### DESCRIPTION

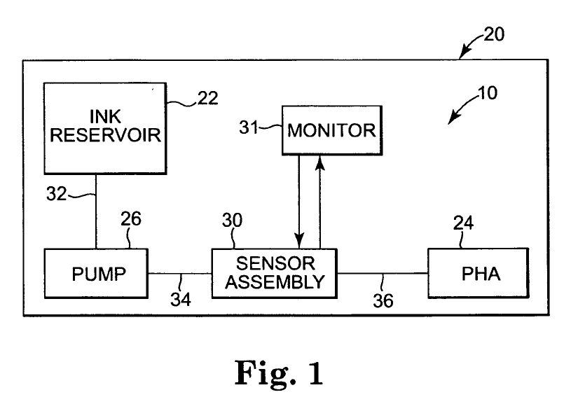

Reference is first made to FIG. 1, wherein an exemplary ink supply system 10 for use with an ink jet printer 20 is schematically depicted. The ink supply system 10 includes an ink reservoir 22 for supplying ink to a print head assembly 24. Ink is moved from the ink reservoir 22 to the print head assembly 24 by a pump 26. As ink moves from the pump 26 to the print head assembly 24, it passes through a bi-directional fluid sensor assembly 30, where the flow of fluid (ink, air and air/ink mixtures, i.e. froth) to the print head assembly 24 is monitored by a monitoring device 31, such as a printer controller. In the illustrated embodiment, the ink reservoir 22, pump 26, fluid sensor assembly 30 and print head assembly 24 are in serial fluid communication with each other via fluid conduits 32, 34, 36, respectively. A continuous fluid channel is defined from reservoir 22 through first conduit 32, pump 26, second conduit 34, fluid sensor assembly 30, and third conduit 36 to print head assembly 24. During normal printing operation, print head assembly 24 is caused to move relative to the recording medium (not shown) such as paper by means of a drive mechanism (not shown) so as to selectively deposit ink thereon. As ink is ejected from print head assembly 24, additional ink is drawn from reservoir 22 by pump 26 and supplied to print head assembly 24. Although only a single ink supply system 10 is illustrated in FIG. 1, the ink jet printer 20 may include a plurality of ink supply systems for delivering a plurality of ink supplies to a plurality of associated print heads, such as in color printers.

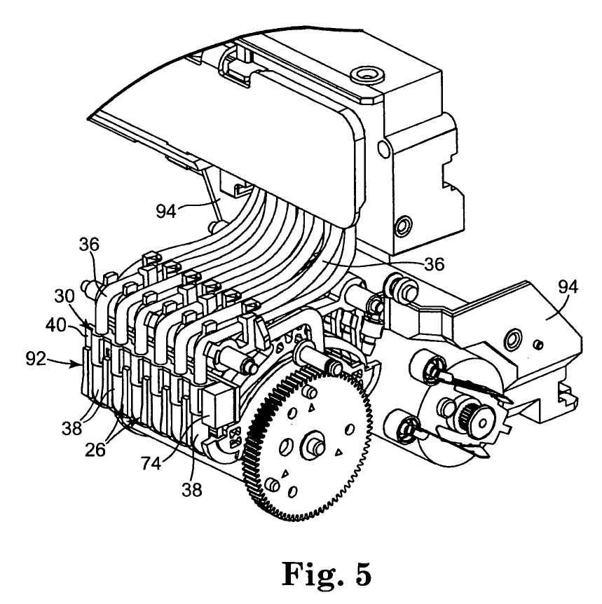

In certain exemplary embodiments, pump 26 is a peristaltic pump having at least one compressible pump tube 38 (FIG. 5), as is known in the art. Generally, ink is moved through pump tube 38 by the application of a compressive force to the pump tube 38, such as by pressing a roller (not shown) against the pump tube 38 with sufficient force so as to create an occlusion within the pump tube 38. The roller (and thus the occlusion) is moved along the length of the pump tube 38, such that ink is forcibly transported ahead of the occlusion. Commonly, a series of rollers are used to create a plurality of successive occlusions along the length of the pump tube 38, such that a peristaltic pumping action is created along the length of the pump tube 38. Moving the compressive forces along the length of the pump tube 38 tends to encourage lateral movement of the pump tube 38, and particularly causes movement of the ends of the pump tube 38. Lateral movement of the pump tube 38 is generally detrimental to efficient pumping operation, and therefore at least the ends of the pump tube 38 can be rigidly held.

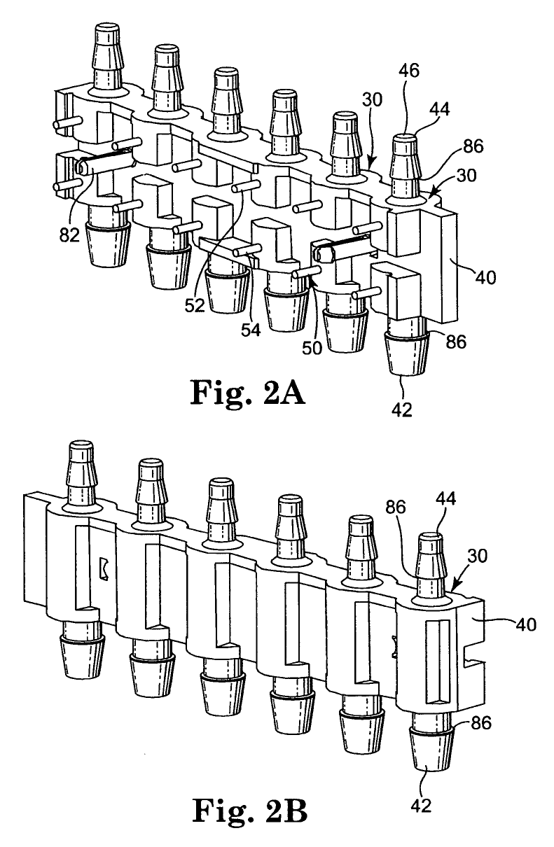

An exemplary embodiment of a fluid sensor assembly 30 is now described with reference to FIGS. 2A-4, where a plurality of fluid sensor assemblies 30 are integrated into a single unit by a common housing 40. In practice, the housing 40 may contain one or more fluid sensor assemblies 30, where a fluid sensor assembly 30 is provided for each of the ink supply systems 20 in the printer 20. For purposes of clarity, only one fluid sensor assembly 30 is described. It is to be understood that where two or more fluid sensor assemblies 30 are integrated into a single unit (as illustrated in FIGS. 2A-4), each of the fluid sensor assemblies 30 are similarly constructed and operated.

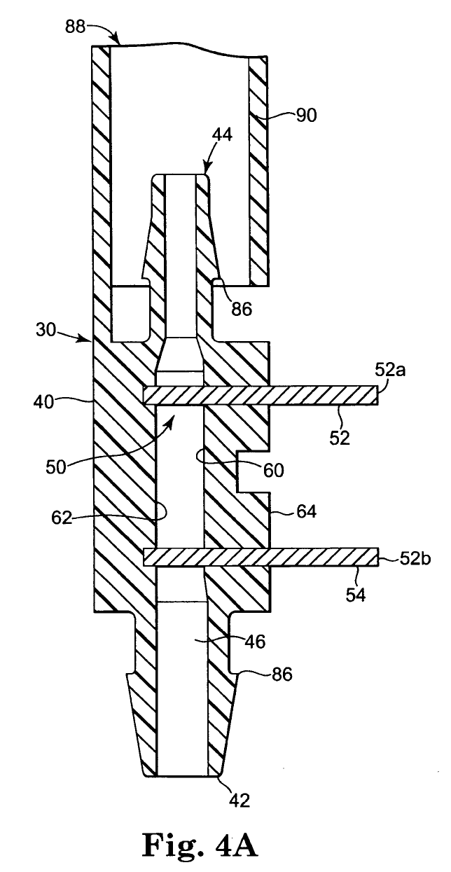

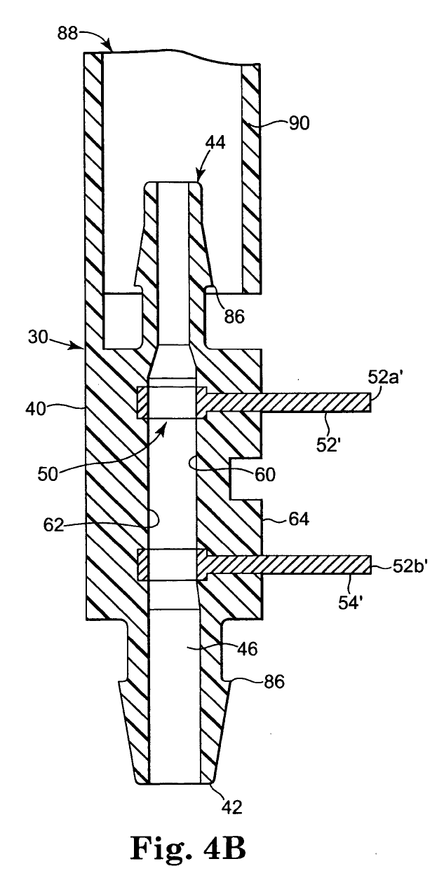

For each fluid sensor assembly 30, the housing 40 has a corresponding inlet 42 and outlet 44. It is to be understood that the terms “inlet” and “outlet” are used for describing fluid flow through the sensor assembly 30 in the primary flow direction (i.e., from the pump 26 toward the print head assembly 24). During some printer procedures, the operation of pump 26 may be reversed and the sensor assembly 30 may operate as a bidirectional sensor, with fluid moving through the sensor from the outlet 44 to the inlet 42. As best seen in FIG. 4A, a fluid conduit 46 extends through the housing 40 from the inlet 42 to the outlet 44. A fluid sensing device 50 is positioned within the fluid conduit 46, and is electrically coupled to monitoring device 31 for detecting changes in the fluid sensing device 50.

In certain exemplary embodiments, the fluid sensing device 50 includes a pair of fluid sensing elements, illustrated in FIG. 4A as longitudinal conductive probe pins 52, 54 extending transversely across the full width or diameter of the fluid conduit 46 and spaced from each other along a longitudinal axis of the fluid conduit 46. By extending probe pins 52, 54 completely across the diameter of the fluid conduit 46, the length and area of the probe pins 52, 54 that is exposed within the fluid conduit 46 is accurately known, the mechanical strength of the device is improved, and variations from probe pin to probe pin and from sensing devise to sensing device are reduced. The profile of probe pins 52, 54 can be shaped to facilitate fluid sensing while minimizing the resistance to fluid flow and reducing the locations where clogs could nucleate. The cross-sectional profile of probe pins 52, 54 can be of any suitable shape, including round, oval, square, thin blades, or other hydrodynamic shapes.

The probe pins 52, 54 are pressed or molded into the housing 40, which may be formed from a polymer material or the like. As illustrated in FIG. 4A, the probe pins 52, 54 extend completely through one side wall 60 of the fluid conduit 46, across the diameter of fluid conduit 46, and are embedded in the opposite side wall 62 of the fluid conduit 46. An end 52a, 54a of each probe pin 52, 54 extends past an exterior surface 64 of the housing 40.

In another exemplary embodiment illustrated in FIG. 4B, the pair of fluid sensing elements includes a pair of annular probes 52′, 54′ extending around the circumference of the fluid conduit 46 and spaced from each other along a longitudinal axis of the fluid conduit 46. The annular probes 52′ 54′ can be overmolded in the housing 40, such that the annular probes 52′, 54′ are contiguous with the interior surface of the fluid conduit so as to be in contact with fluid flowing through fluid conduit 46. A connection pin 52a′, 54a′ is connected to each annular probe 52′, 54′, and extends past the exterior surface 64 of the housing 40. The shape of annular probes 52′, 54′ facilitates fluid sensing while providing no additional resistance to fluid flow and reducing the locations where clogs could nucleate.

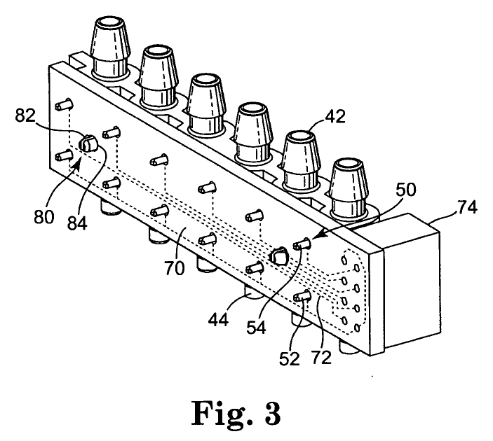

As best seen in FIG. 3, the ends 52a, 54a, 52a′, 54a′ of probe pins 52, 54 and annular rings 52′, 54′ are electrically connected to conductive circuit traces 72 on a printed circuit board 70. The circuit traces 72 are in turn electrically connected to an electrical connector 74 on the printed circuit board 70. The electrical connector 74 is configured for electrical connection with the fluid monitoring device 31, such as a printer controller. In this manner, signals may be communicated between the fluid monitoring device 31 and the fluid sensing device(s) 50 via the electrical connector 74 and circuit traces 72. In certain embodiments, the printed circuit board 70 includes conductive circuit traces 72 laid out such that a signal sent to the fluid sensing device(s) 50 can be detected to determine whether the electrical connector 74 has been properly mated, and thereby provide assembly verification and on-board diagnostics for the fluid sensing device(s) 50.

The electrical connector 74 provided on the printed circuit board 70 provides several advantages. Regardless of the number of fluid sensor assemblies 30 used in the printer 20, assembly of the ink delivery system 10 is simplified because only a single electrical connection is required to be made, and costs are reduced because only one electrical connector 74 is required. Thus, the illustrated configuration having a single electrical connector 74 for a plurality of fluid sensor assemblies 30 is particularly beneficial in reducing the size, complexity and cost of the apparatus, especially when more than one fluid sensor assembly 30 is integrated into a single housing 40.

The housing 40 is secured to a printed circuit board 70 by suitable fastening means 80 such as, for example, latching arms 82 that are integrally formed with the housing 40 and that engage corresponding openings 84 on the printed circuit board 70 (FIG. 3). The fastening means may alternately comprise separate fastening devices such as screws, or an adhesive. The probe pins 52, 54 or annular rings 52′, 54′ and the electrical connector 74 may be connected to the circuit traces 72 of the printed circuit board 70 by soldering or conductive adhesive, for example. If the probe pins 52, 54 or annular rings 52′, 54′ and electrical connector 74 are attached to the circuit traces 72 by traditional flow soldering, the housing 40 and electrical connector 74 are made of a material having a high heat deflection temperature to resist heat induced deformation. Suitable exemplary materials include Valox® 457 available from General Electric Company, or nylon with 15% glass fill. If the probe pins 52, 54 or annular rings 52′, 54′ and electrical connector 74 are attached to the circuit traces 72 with conductive adhesive, a wider variety of materials may be used for the housing 40 and electrical connector 74. The use of a conductive adhesive is also beneficial in that a lead-free assembly is possible. In some embodiments, the housing 40 may be adequately secured to the printed circuit board 70 by probe pins 52, 54 alone, such that additional fastening means 80 are not required.

The fluid conduits 34, 36 are typically flexible polymer tubes, and in a certain exemplary embodiments the inlet 42 and outlet 44 of the housing 40 include barb features 86 to create a secure connection with the fluid conduits 34, 36. In one exemplary embodiment, and as best seen in FIG. 4A, the inlet 42 and the outlet 44 may be configured to engage differently sized conduits 34, 36, such that the size of the fluid conduit 46 within the housing 40 changes between the inlet 42 and the outlet 44. In such an embodiment, probe pins 52, 54 can be positioned within a section of the fluid conduit 46 having a constant cross-sectional area. Additionally, the housing 40 may be provided with strain relief features 88 (illustrated in FIGS. 4A and 4B) to protect the barb/conduit interface and maintain a minimum bend radius of the fluid conduits 34, 36. In certain embodiments, the strain relief feature 88 is a collar or ring 90 extending from the housing 40 and surrounding the inlet 42 and/or outlet 44.

When the pump 26 is a peristaltic pump, the pump tube 38 of the peristaltic pump is directly engaged to the inlet 42 of the fluid sensor assembly 30. In such a configuration, the inlet 42 locates and holds the pump tube 38 in the proper position. Further, by positioning the fluid sensor apparatus 30 immediately adjacent the pump 26, the need to use the pump 26 to carefully meter ink flow is eliminated, thereby simplifying control and operation of the pump 26. The bi-directional nature of the sensor assembly 30 is particularly useful in this configuration, as the pump 26 may be operated in reverse during various aspects of printer operation and maintenance. Further, the housing 40 acts as a coupler between the pump tube 38 and the conduit 36, thereby eliminating the need for a separate coupler component.

During normal printing operations, ink flows through the pump 26 to the inlet 42 of the fluid sensor assembly 30. When fluid passes by the sensing elements of fluid sensing device 50 (probe pins 52, 54 or annular rings 52′, 54′), the fluid is detected by the fluid monitoring device 31. The fluid passes through the fluid conduit 46 to the outlet 44 of the fluid sensor assembly 30, where it exits into fluid conduit 36 connected to the print head assembly 24. Depending upon the signals sent from the monitoring device 31 to the sensing elements of fluid sensing device 50, the fluid sensing device 50 may be used, for example, to detect the moment when ink, air or a combination of air and ink (froth) passes each sensing element of the fluid sensing device 50, and from that information determine flow rates, volume of ink remaining, and an out of ink condition, for example. Further, the fluid sensing device may be used to determine such information for fluid flows in either direction through the fluid conduit 46.

In FIG. 5, a housing 40 integrating a plurality of fluid sensor assemblies 30 in a single unit is shown installed in the ink supply system 10 of the printer 20. A pump assembly 92 comprising a plurality of peristaltic pumps 26 is provided, with each pump 26 of the assembly 92 having a corresponding fluid sensor assembly 30. The pump assembly 92 and the housing 40 are both mounted on support members 94 of the printer 20, although in other embodiments the housing 40 may be secured only to the pump assembly 92, while the pump assembly 92 is mounted on support members 94 of the printer 20. Those skilled in the art will recognize a variety of suitable configurations for securing the pump assembly 92 and the housing 40 within the printer 20. The pump tubes 38 of the peristaltic pumps 26 are directly connected to the inlets 42 of the corresponding fluid sensor assembly 30, although in other embodiments an intermediate fluid conduit can fluidically couple the pumps 26 to the inlets 42 of the corresponding fluid sensor assembly 30. Ink is supplied to the pumps 26 of the assembly 92 from remote ink source 22 (not shown in FIG. 5), while the outlet 44 of the fluid sensor assembly 30 is in fluid communication with the print head assembly 24 (not shown in FIG. 5) via conduit 36.

Although exemplary embodiments have been illustrated and described herein for purposes of description, it will be appreciated by those of ordinary skill in the art that a wide variety of alternate and/or equivalent implementations may be substituted for the specific embodiments shown and described without departing from the spirit and scope of the present invention. This application is intended to cover any adaptations or variations of the embodiments discussed herein. Therefore, it is manifestly intended that the foregoing discussion is illustrative only, and the invention is limited and defined only by the following claims and the equivalents thereof.

What is claimed is:

1. An apparatus for use with an ink supply system of a printer, comprising:
a housing having an inlet, an outlet and a longitudinal fluid conduit extending therebetween;
a fluid sensing device extending from a first side of the fluid conduit to an opposite side of the fluid conduit; and
a monitoring device electrically coupled to the fluid sensing device for detecting changes in the fluid sensing device.

2. The apparatus of claim 1, further comprising a printed circuit board, wherein the housing is mounted on the printed circuit board and the fluid sensing device is electrically coupled to circuit traces of the printed circuit board.

3. The apparatus of claim 2, further comprising an electrical connector mounted on the printed circuit board and electrically attached to the circuit traces for electrically connecting the fluid sensing device to the monitoring device.

4. The apparatus of claim 2, wherein the printed circuit board is electrically coupled to the monitoring device, and wherein the circuit traces of the printed circuit board include a circuit for verifying electrical connection between the printed circuit board and the monitoring device.

5. The apparatus of claim 1, wherein the fluid sensing device comprises a first probe and a second probe, each probe extending from the first side of the fluid conduit to the opposite side of the fluid conduit, the first and second probes spaced from each other along a longitudinal axis of the fluid conduit.

6. The apparatus of claim 5, wherein the probes of the fluid sensing device comprise a first probe pin and a second probe pin, each probe pin extending transversely across a width of the fluid conduit.

7. The apparatus of claim 6, wherein the first and second probe pins pass through a side wall of the fluid conduit to an exterior surface of the housing.

8. The apparatus of claim 7, wherein the first and second probe pins are press-fit into the side wall of the housing.

9. The apparatus of claim 1, wherein at least one of the inlet and outlet is configured for attachment to a flexible fluid conduit, the housing further comprising a strain relief collar extending around the at least one of the inlet and the outlet to maintain a minimum bend radius of the flexible fluid conduit.

10. The apparatus of claim 1, wherein the housing comprises a plurality of longitudinal fluid conduits, each of the plurality of fluid conduits having an associated fluid sensing device extending transversely across the width of the fluid conduit, and an associated inlet and outlet for each of the plurality of fluid conduits.

11. The apparatus of claim 5, wherein the probes of the fluid sensing device comprise a first annular probe and a second annular probe, each annular probe extending around the circumference of the fluid conduit and contiguous with an interior surface of the fluid conduit.

12. The apparatus of claim 11, wherein the first and second annular probes include a connection pin passing through a side wall of the fluid conduit to an exterior surface of the housing.

13. The apparatus of claim 12, wherein the first and second annular probes are overmolded in the housing.

14. An ink supply system for a printer, comprising:
a pump for providing pressurized ink to a print head assembly;
a coupler assembly having an inlet for receiving ink from the pump, an outlet for supplying ink to the printhead assembly, and a longitudinal fluid channel connecting the inlet and outlet;
a pair of probes passing through a sidewall of the coupler to the fluid channel and extending across the fluid channel;
a printed circuit board mounted to the coupler and electrically connected to the probes, the printed circuit board configured for providing electrical connection between the probes and a printer controller.

15. The ink supply system of claim 14, wherein the printed circuit board includes a circuit for verifying electrical connection between the probes and the printer controller.

16. The ink supply system of claim 14, wherein the inlet and outlet of the coupler assembly are configured for connection to flexible tubes.

17. The ink supply system of claim 16, wherein the inlet of the coupler assembly is configured for connection to a flexible tube having a first diameter and the outlet of the coupler assembly is configured for connection to a flexible tube having a second diameter different from the first diameter.

18. The ink supply system of claim 14, wherein the pump is a peristaltic pump having a compressible pump tube, and wherein the coupler assembly inlet is connected to and maintaining the position of a terminal end of the pump tube during compression of the pump tube.

19. The ink supply system of claim 14, wherein the pair of probes comprise conductive pins extending transversely across the width of the fluid channel.

20. The ink supply system of claim 14, wherein the pair of probes comprise conductive annular rings extending around the circumference of the fluid channel and contiguous with a surface of the fluid channel.

21. The ink supply system of claim 14, the coupler including a plurality of fluid channels, each of the plurality of fluid channels having an associated pair of probes passing through a sidewall of the coupler assembly into the fluid channel and extending completely across the fluid channel, and an associated inlet and outlet for each of the plurality of fluid channels.

22. An apparatus for sensing fluids within an ink supply system of a printer, comprising a plurality of fluid conduits each having an associated fluid sensing device therein, the plurality of fluid conduits and associated fluid sensing devices secured to a printed circuit board having a single electrical connector thereon, wherein the electrical connector is electrically coupled to each of the plurality of fluid sensing devices by conductive traces on the printed circuit board.

23. The apparatus of claim 22, wherein the electrical connector is configured for electrical connection with a monitoring device for detecting changes in the fluid sensing devices.

24. The apparatus of claim 22, wherein the plurality of separate fluid conduits and sensing devices are integrated in a single housing.

25. The apparatus of claim 22, wherein each fluid sensing device comprises:
a pair of probes passing through a sidewall of the associated fluid conduit and extending from a first side of the fluid conduit to a second side of the fluid conduit.

26. The apparatus of claim 22, wherein the pair of probes comprise conductive pins extending transversely across a width of the fluid conduit.

27. The apparatus of claim 22, wherein the pair of probes comprise conductive annular rings extending around the circumference of the fluid conduit and contiguous with a surface of the fluid conduit.
